(19) United States
(12) Patent Application Publication
(10) Pub. No.: US 2011/0173018 A1
(43) Pub. Date: Jul. 14, 2011

(54) SYSTEM AND METHOD FOR USE OF PREDICTION MARKET DATA TO GENERATE REAL-TIME PREDICTIVE HEALTHCARE MODELS

(76) Inventors: Ron M. Hoffner, Minneapolis, MN (US); Jean W. Rawlings, Roy, UT (US)

(21) Appl. No.: 12/685,208

(22) Filed: Jan. 11, 2010

(51) Int. Cl. G06Q 50/00; G06Q 10/00; G06N 5/02; G06F 15/18

(52) U.S. Cl. 705/2; 706/50; 706/12

(57) ABSTRACT

In a computer-implemented system and method for generating a real-time predictive healthcare model that can predict future costs or health-related behaviors associated with a population of interest, historical healthcare data associated with the population members is used to generate an actuarial predictive model for the population. The actuarial predictive model enables identification of precursors for the population members, such as potential actions that can be taken by the population members to improve their future health and/or reduce future healthcare costs. The precursors are used to design one or more prediction markets and generate prediction market results based upon the market participants' responses. The prediction markets results, along with the actuarial predictive model, are used to generate a real-time predictive model. Later-received actuarial data associated with the population may be used to verify the accuracy of the prediction market results and update the real-time and actuarial predictive models.

### FIELD OF THE INVENTION

The present invention relates generally to a system and method for generating real-time predictive healthcare models that enable assessment of future healthcare costs and behaviors based upon a combination of historical healthcare data and data generated by prediction markets.

### BACKGROUND OF THE INVENTION

Prediction markets (also called “decision markets”) are speculative markets created for the purpose of making predictions. Assets are created whose final cash value is tied to a particular event (e.g., will the next US president be a Republican) or parameter (e.g., total sales next quarter). The current market prices can then be interpreted as predictions of the probability of the event or the expected value of the parameter.

The prediction market poses questions to a group of stakeholders who respond with their opinions of what is most likely to happen in the future. The stronger the opinion, the greater the number of points stakeholders allocate to their position. This may be done anonymously to encourage a candid response. Within a company, decision-makers can use prediction markets to access opinions from the entire workforce who otherwise may be reluctant or unable to share their opinions and knowledge.

For example, in the healthcare arena, prediction markets can be implemented to offer a low-cost, efficient and predictive tool for providing a quantitative assessment, in advance, of potential actions or offerings of an employer or health plan administrator such as the desirability and success of specific health plan features, how members or employees will respond to wellness programs, and how to increase engagement of members in particular health programs. Thus, prediction markets offer valuable insights into the rapidly changing world of health care.

### SUMMARY OF THE INVENTION

The present invention enables an entity to capitalize on the dynamic predictive advantages of prediction markets as well as the reliability of real-world historical health data. Instead of running a prediction market in isolation, the present invention links prediction markets and predictive tools that utilize historical data (“actuarial models”) to provide a comprehensive methodology for generating and verifying a real-time predictive model that enables improved assessment of, for example, future healthcare costs and behaviors. The real-time predictive model generated using this methodology can be utilized to provide health care decision makers with a comprehensive view of one or more patient populations of interest.

Additionally, the predictive data generated by the prediction market(s) may be compared with subsequent claim data for the population at issue to verify accuracy of the market predictions as well as to identify health care trends to be integrated into the comprehensive predictive model.

In one implementation of the present invention, an actuarial model may be utilized to identify at-risk employees or health plan members. A prediction market may then be utilized to gauge the attitudes and actions of these at-risk individuals, with the results used to generate targeted messaging, programs and/or other actions that are most likely to address the needs of the at-risk individuals, for example, reducing the future health care costs for these individuals.

An exemplary computer-implemented system and method for generating predictive data associated with a health care population may store historical healthcare data associated with members of a population of interest, predictive model data for the population of interest, and precursor data based upon the predictive model data in at least one electronic database. The system and method may further use at least one computer processor to: generate prediction market input data associated with the precursor data; generate a prediction market based upon the prediction market input data; receive market participant response data; generate prediction market result data based upon the market participant response data; and generate real-time predictive model data using the stored predictive model data and the prediction market result data. An electronic display may be provided to display the real-time predictive model data.

In some embodiments, the predictive model data may be generated using the stored historical healthcare data and/or the precursor data may be generated based upon the predictive model data. In some embodiments, the real-time predictive model data may be used to update the stored predictive model data. The precursor data may include data representing at least one potential action that a member of the population of interest can take to improve the member's future health or reduce the member's future healthcare costs. The historical healthcare data associated with members of a population of interest may be updated upon receipt of new actuarial data concerning the population of interest, and the updated historical healthcare data is used to update the stored predictive model data. Additionally, later-received actuarial data concerning the population of interest may be used to assess the accuracy of the prediction market result data.

In some embodiments of the computer-implemented system and method according to the present invention, the predictive model data and real-time predictive model data enable prediction of future healthcare costs associated with the population of interest and/or future healthcare behavior associated with the population of interest.

The features, utilities and advantages of the various embodiments of the invention will be apparent from the following more particular description of embodiments of the invention as illustrated in the accompanying drawings.

### BRIEF DESCRIPTION OF THE DRAWINGS

FIG. 1 provides a block diagram of an exemplary computer-implemented system 100 for generating a real-time predictive healthcare model in accordance with the present invention.

FIG. 1A provides a block diagram of an alternative exemplary computer-implemented system 100 for generating a real-time predictive healthcare model in accordance with the present invention.

FIG. 2 provides an exemplary illustration of potential actions generated by DPI system 103 and prediction market input data generated by consulting terminal 104 of system 100.

FIG. 3 provides an exemplary display of a prediction market generated using prediction market input data provided to prediction market module 105 of client interface 110.

FIG. 4 provides an exemplary display of prediction market results generated by prediction market module 105.

FIG. 5 provides an exemplary display of a report of results generated by report engine 106 using a real-time predictive model generated in accordance with the present invention.

FIG. 6 provides a functional block diagram of an exemplary computer-implemented method for generating a real-time predictive healthcare model in accordance with the present invention.

### DETAILED DESCRIPTION

The present invention will now be described in further detail with reference to the accompanying drawings.

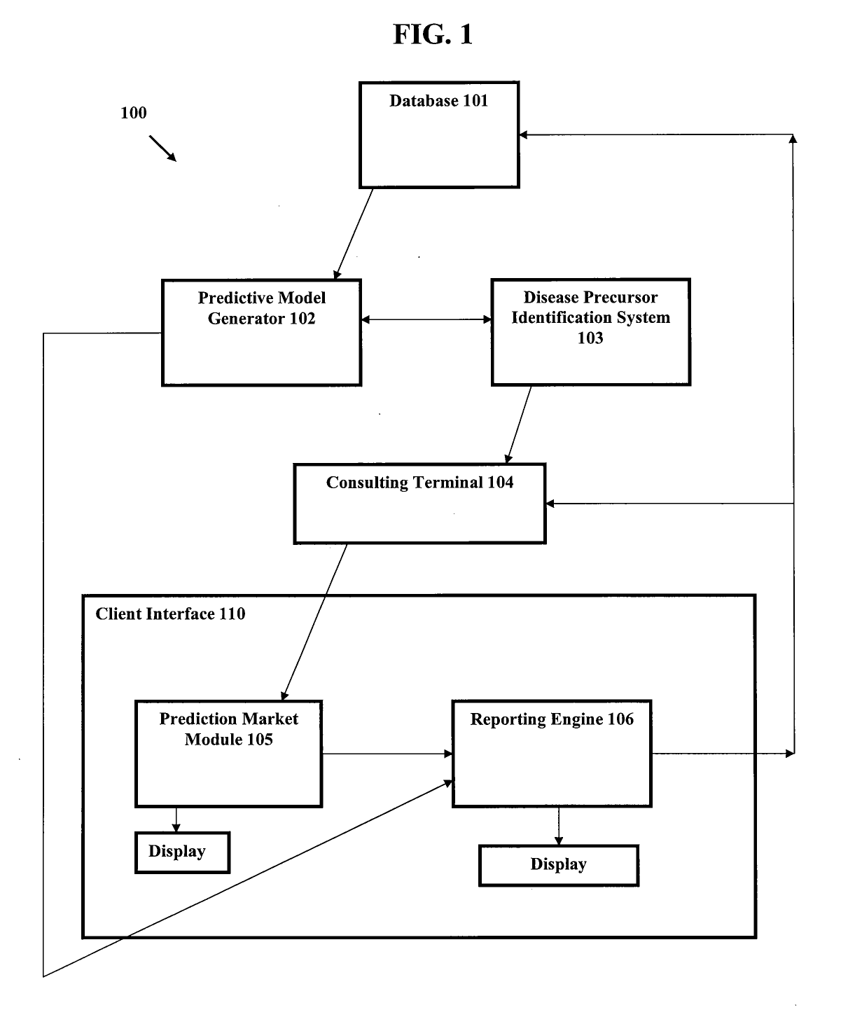

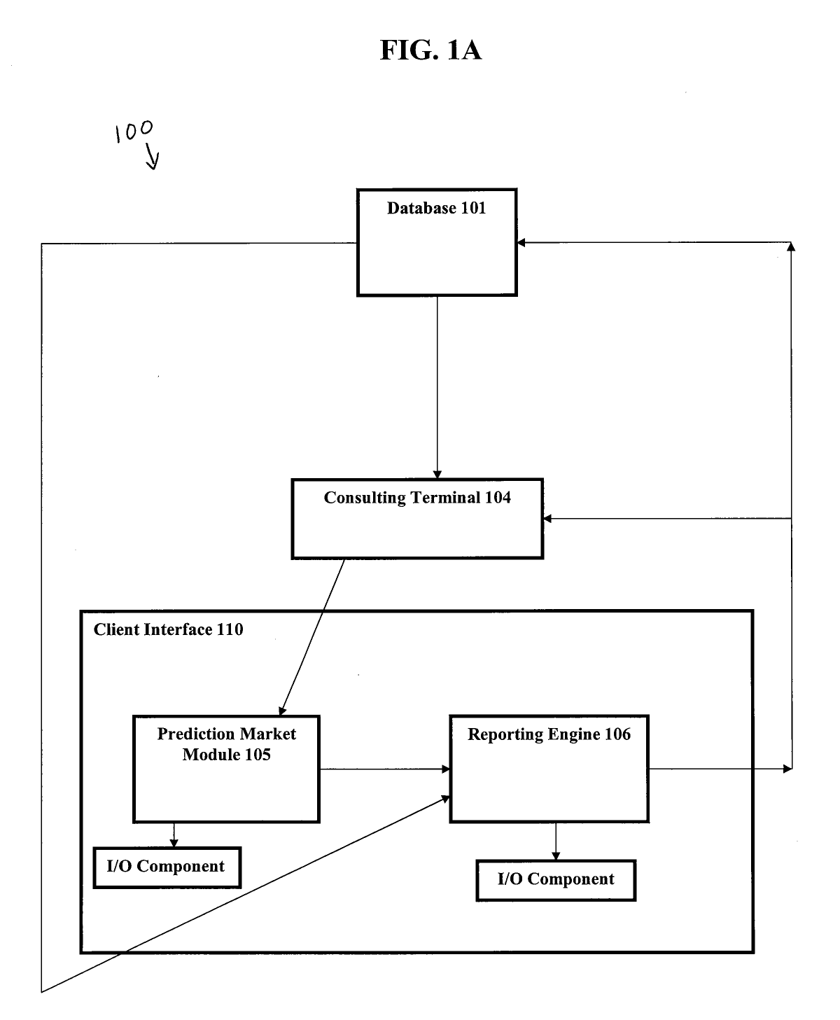

FIG. 1 illustrates a block diagram of an exemplary computer-implemented system 100 for generating a real-time predictive healthcare model associated with at leas one patient, health plan member or other population in accordance with the present invention. Notably, while the system 100 is described in terms of a number of linked components, it is contemplated that the methodology of the present invention may be implemented using different configurations and combinations of computer hardware and software. For example, the components of system 100 may be implemented using one or more computer processors and/or servers, one or more electronic storage devices, and one or more input-output devices, or other combinations of components as would be apparent to those of skill in the art. Assuming the present invention is implemented using a network of components, these components can be communicatively linked in a variety of network configurations, such as local and wide area networks, virtual private networks, the Internet and other public networks, using wired and/or wireless communication links and various types of I/O devices.

The system 100 includes a database 101 of historical health-related data containing information for one or more defined health care populations, such as employees of one or more entities or members of one or more health care plans. The historical data may include past health-related diagnoses, in-patient and out-patient treatments and services, prescriptions, facility charges, and other health-related aspects of the health care of the population and may include previously adjudicated claim data associated with the members of the health care population. Previously adjudicated claim data may include claim data associated with medical procedures and services, surgeries, prescriptions, ancillary services, in-patient and out-patient facility charges, and any other types of health-related claim data. The data may be obtained from one or more sources, including one or more historical medical databases, health claim adjudication systems or any other desired source. The historical data stored in database 101 may be automatically and/or manually updated or augmented, for example, on a periodic basis, as new claim data and other types of historical data become available.

A predictive model generator 102 is communicatively coupled to the database 101 and comprises a computer processor for generating a predictive model that may be used to predict one or more aspects concerning future healthcare behaviors, costs, etc. For example, the predictive model generator 102 may implement the predictive methodologies and analytical tools described in U.S. patent application Ser. No. 12/562,608, entitled “Apparatus, System, and Method for Natural History of Disease,” filed on Sep. 18, 2009, and U.S. patent application Ser. No. 12/605,697, entitled “Apparatus, System and Method for Rapid Cohort Analysis,” filed on Oct. 26, 2009, both of which are hereby incorporated herein by reference, to identify one or more typical progression pathways of a selected disease or health-related condition. Alternative predictive methodologies may also be implemented, for example, using known statistical regression analysis of historical claim data, to generate predictive models concerning future healthcare costs and behaviors. The predictive model may enable identification of one or more variables having the greatest relative impact on future healthcare costs or behaviors (“key variables”).

The predictive model generator 102 may identify one or more key variables that are predicted to have a significant impact on future health-related behavior and/or costs relative to other variables in the model(s), for example, by identifying the most highly weighted variables in the equations associated with the predictive model(s). For illustrative purposes, reference is made to U.S. Pat. No. 7,444,291, entitled “System and Method for Modeling of Healthcare Utilization,” hereby incorporated herein by reference, which describes a method of healthcare resources modeling based upon historical claim data and using linear regression to generate a model that enables the calculation of a “burden of illness” score for one or more members of a population to enable prediction of future healthcare utilization of the members. In the exemplary equation provided for calculating the burden of illness for each member ('291 patent at c. 10, 1. 5), various “explanatory variables” are given different weights (represented by the coefficients “b” in the equation). The assigned weights for each explanatory variable specify the weight to be attributed to each variable. By comparing the relative weights assigned to each variable, identification of one or more key variables having the highest relative weights can be identified.

Notably, the exemplary process described above is intended to illustrate one possible methodology for identifying key variables and is not intended to limit the possible methodologies that may be implemented in accordance with the present invention.

After generating one or more predictive models based upon at least a portion of the historical data stored in database 101 and identifying one or more key variables, the predictive model generator 102 may further store the predictive model(s) and key variable(s) in an associated database. Generator 102 may also include a communication component for requesting and receiving data from database 101, for example, on a periodic basis, to enable periodic adjustments to the predictive model(s) as the historical data is updated.

The key variable(s) identified by the predictive model generator 102 are provided to a computer-implemented disease precursor identification (“DPI”) system 103 comprising a computer processor that uses the variables to identify precursors to various diseases experienced by members of the population of interest and potential actions that individuals within a population of interest can take to address these precursors to achieve an improvement, such as improving their health and/or lowering their healthcare costs. A system for identifying potential actions directed to impacting the key variable(s) identified by the predictive model generator 102 is described in pending U.S. patent application Ser. No. 12/562,608, entitled “Apparatus, System, and Method for Natural History of Disease,” filed on Sep. 18, 2009, which is incorporated herein by reference and describes the generation of a lifestyle management plan for an individual based upon an analysis of the individual's historical health claim data that presents options for avoiding the onset of one or more specific diseases once an individual has been determined to have various precursors of the specific disease(s). The DPI system 103 may further include a database for storing the precursors and potential actions as precursor data and a communication component for requesting, receiving and transmitting the precursor data to/from predictive model generator 102, for example, on a periodic basis, to enable periodic updates.

As illustrated in FIG. 1A, in an alternative configuration of the system 100, the historical data, predictive model data and precursor data are stored in at least one database 101. In this implementation, predictive model generator 102 and DPI system 103 are not components of the system 100.

The precursor data generated by DPI system 103 is provided to a consulting terminal 104 that stores and displays the precursors and potential actions to enable viewing and analysis by a user and receives prediction market input data input by the user in response to the precursors and potential actions identified by the DPI system 103. The consulting terminal 104 may include a computer processor coupled to a display and an input component to receive user inputs. The terminal 104 may further include a communication component for transmitting the prediction market questions to a client interface 110.

The prediction market input data received by the consulting terminal 104 may include prediction market question data that is subsequently provided to the client interface for display to participants in a prediction market as discussed in further detail below.

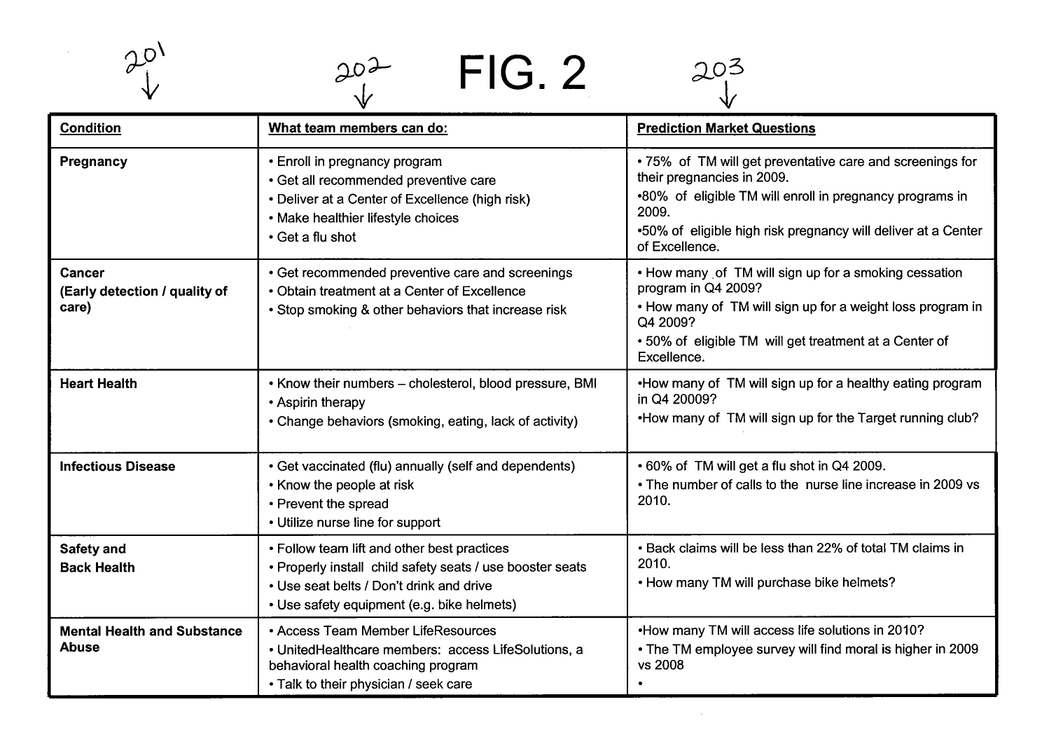

FIG. 2 provides an exemplary illustration of the precursors and potential actions provided by DPI system 103 to the consulting terminal 104 and the associated prediction market input data that may be input by a user of the consulting terminal 104 in response to the data from the DPI system 103. In FIG. 2, column 201 indicates a selected disease or condition experienced by one or more members of the population of interest. Column 202 displays potential action data received from the DPI system 103. This data provides suggested behaviors of the members of the population that are experiencing the relevant disease or condition. The potential action data is displayed by the consulting terminal 104.

In response to the potential action data, a user of the consulting terminal 104 may enter corresponding prediction market input data that can be used in a prediction market to assess the future behavior of the population of interest. For example, exemplary prediction market input data input by a user of consulting terminal 104 is provided in column 203 of FIG. 2. Alternatively, the prediction market input data may be automatically generated and displayed by consulting terminal 104 for user review. In one implementation, the prediction market input data may be automatically generated based upon previously created prediction market input data, prediction market result data (discussed below) and/or upon other data inputs, for example, user inputs indicating user preferences associated with the creation of the prediction market input data. In some instances, the prediction market input data may be formatted in an interrogatory format (see questions included in Column 203 of FIG. 2), while in other instances, the prediction market input data may be formatted in an affirmative statement format (see statements included in Column 203 of FIG. 2), and in some instances a combination of these and other desired formats may be used.

Once the user has finalized the prediction market input data using consulting terminal 104, the terminal may store the finalized data and may also provide the finalized prediction market input data to a prediction market module 105 of the client interface 110. The prediction market input data is used by the prediction market module 105 to generate and display one or more prediction markets and enable user participation in the prediction market. Users input market participant data into prediction market module 105, which is used by the module 105 to generate prediction market result data.

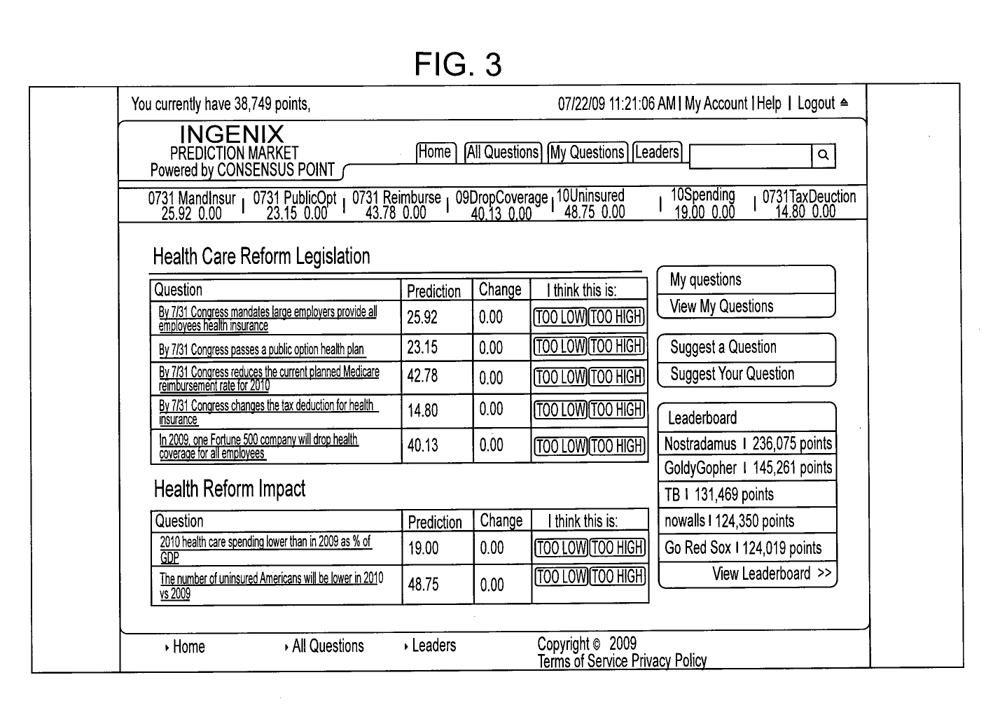

An exemplary prediction market that may be generated and displayed by prediction market module 105 is illustrated in FIG. 3. In this exemplary prediction market, participants in the market are asked to read a question or statement, view the prediction percentage indicating the percentage of market participants that agree with the question or statement, and enter their view as to whether this percentage is, in their opinion, too high or too low and how much (numerically) the percentage should be adjusted. The responses entered by the participants are stored as market participant data. The accuracy of each participant's predictions determines the number of points earned by the user in the prediction market. In the example depicted in FIG. 3, the participants with the highest numbers of points are displayed. Additionally, the participant is able to view the questions that he/she has answered (the “View My Questions” link) and to suggest questions (the “Suggest Your Question” link). The participants' participation in the prediction market generates prediction market result data, which is provided from the prediction market module 105 to a reporting engine 106 of client interface 110.

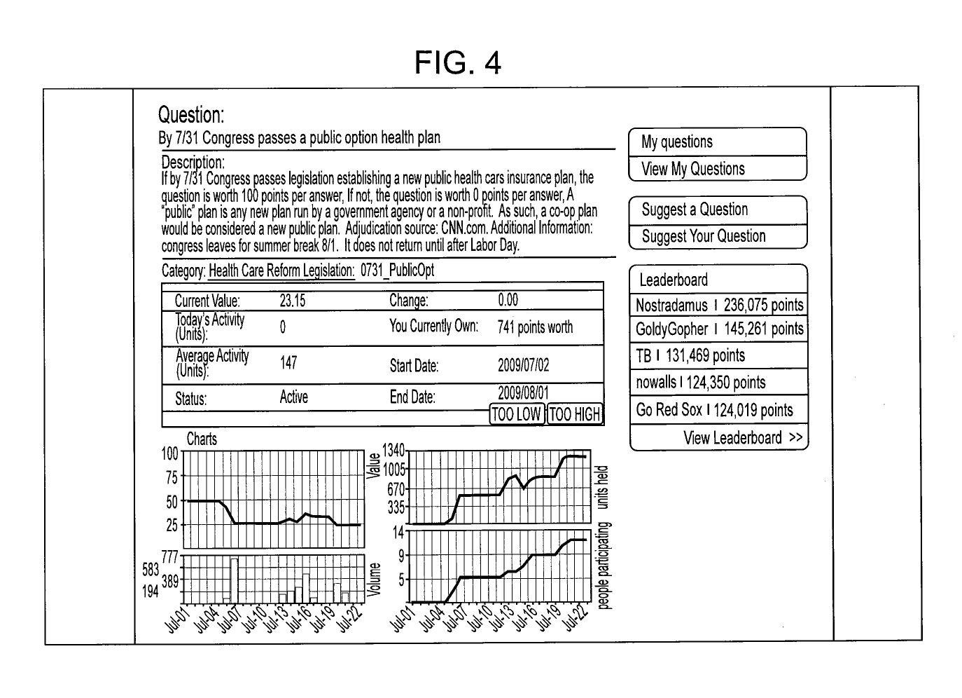

FIG. 4 provides an exemplary display of real-time prediction market result data generated using the participant response data for one question in the prediction market illustrated in FIG. 3. The display provides a description of the question and how points are to be awarded, as well as the current value attributed to the question and other information about the user's activity and points. Charts are also provided and represent the volume of market participation for this question, the number of people participating in the market, and the units held by the participants.

In one implementation of system 100, the prediction market module 105 provided using the “Foresight Platform” offered by Consensus Point of Nashville, Tenn. (www.consensuspoint.com). Alternatively, other prediction market platforms and technologies may be utilized.

With reference to FIG. 1, reporting engine 106 uses the prediction market result data and predictive model data from the predictive model generator 102 to generate real-time predictive model data, which is used to generate a real-time predictive healthcare model that may be displayed to the user in real time by the client interface 110. The real-time predictive model data and associated display may be continually or periodically updated using the prediction market result data from prediction market module 105 as well as any updated predictive model data received from predictive model generator 102, which may be updated, for example, upon receipt of additional historical data, such as recently adjudicated health claim data. Thus, a client is able to use the real-time predictive model to assess future healthcare costs and/or behaviors.

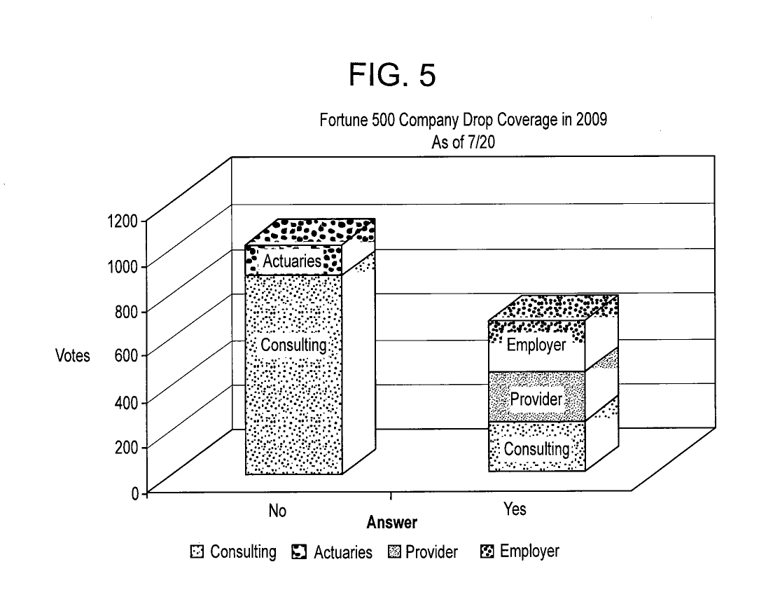

FIG. 5 provides an exemplary illustration of a report generated by the report engine 106 that provides a real-time prediction (as of Jul. 20, 2009) of a future event relating to healthcare reform, specifically whether a Fortune 500 company will drop healthcare coverage for its employees in 2009. The number of “yes” votes and “no” votes are graphically displayed and divided based upon the source of the data, including actuaries, consultants, employers, and healthcare providers.

The real-time predictive model data is also provided to consulting terminal 104 to enable revision or creation of new prediction market input data based upon the real-time predictive model. Consulting terminal 104 may also receive updated precursor and potential action data from DPI system 103, providing an additional basis for updating the prediction market input data.

The real-time predictive model data may also be provided as an input to the predictive model generator 102 to enable real-time adjustment of the historical predictive model.

Additionally, as newly adjudicated claim data is added to database 101, various components of the system 100 may be updated dynamically. For example, new historical data may be provided to the predictive model generator 102, which uses the new historical data to generate an updated predictive model, which is in turn used to generate updated key variables for DPI system 103. DPI system 103 then updates the precursor and potential action data provided to consulting terminal 104, which enables updating of the prediction model input data provided to prediction market module 105. The updated prediction market input data is used to generate updated prediction market result data, which, in turn, updates the real-time prediction model generated by the reporting engine 106. Updates to the predictive model generated by predictive model generator 102 may also be provided directly to reporting engine 106.

Additionally, prediction market result data may be compared with actuarial (historical) data stored in database 101, for example, using the predictive model generator 102 or a computer-implemented comparator (not shown) to determine the accuracy of the prediction market result data. Information concerning this accuracy determination may be provided in electronic form, for example, to consulting terminal 104 to enable adjustment of the prediction market input data, for example, to improve accuracy or better reflect observed (actual) healthcare costs and/or behaviors.

In one implementation of the system and method according to the present invention, the predictive model generator 102 may be utilized to identify at-risk members of a population of interest and the key variable(s) affecting the future costs and/or behaviors associated with these members based upon historical data from database 101. For example, such at-risk members may be identified using the predictive methodologies and analytical tools described in U.S. patent application Ser. No. 12/562,608, entitled “Apparatus, System, and Method for Natural History of Disease,” filed on Sep. 18, 2009, and U.S. patent application Ser. No. 12/605,697, entitled “Apparatus, System and Method for Rapid Cohort Analysis,” filed on Oct. 26, 2009 (discussed above), or may be identified based upon relative burden of illness scores as discussed in U.S. Pat. No. 7,444,291 (discussed above).

Once the predictive model generator 102 has identified one or more at-risk members of the population and their associated key variable(s), the key variables are provided to DPI system 103, which identifies precursors and potential actions that may be taken by the at-risk members to improve their future health, reduce their future healthcare costs, or otherwise improve their future health-related prospects.

The precursors and potential actions for the at-risk members generated by DPI system 103 are provided to consulting terminal 104, which is used to generate prediction market input data associated with the future costs and/or behaviors of the at-risk members. The prediction market input data associated with the at-risk members is provided to the prediction market module 105 of client interface 110, where it is used to generate prediction markets. The resulting prediction market result data associated with the at-risk members is provided to reporting engine 106, which uses the data to generate real-time predictive model data associated with the at-risk individuals, which is used to generate a display of real-time predictions concerning the attitudes and future actions of the at-risk members. This information may be used, for example, to provide targeted messaging and programs to the at-risk members to ameliorate their future health and associated costs. Additionally, as actuarial data is received (for example, subsequent health claim data for the at-risk members) and stored in database 101, the predictions of the real-time predictive model may be verified and the model adjusted as desired.

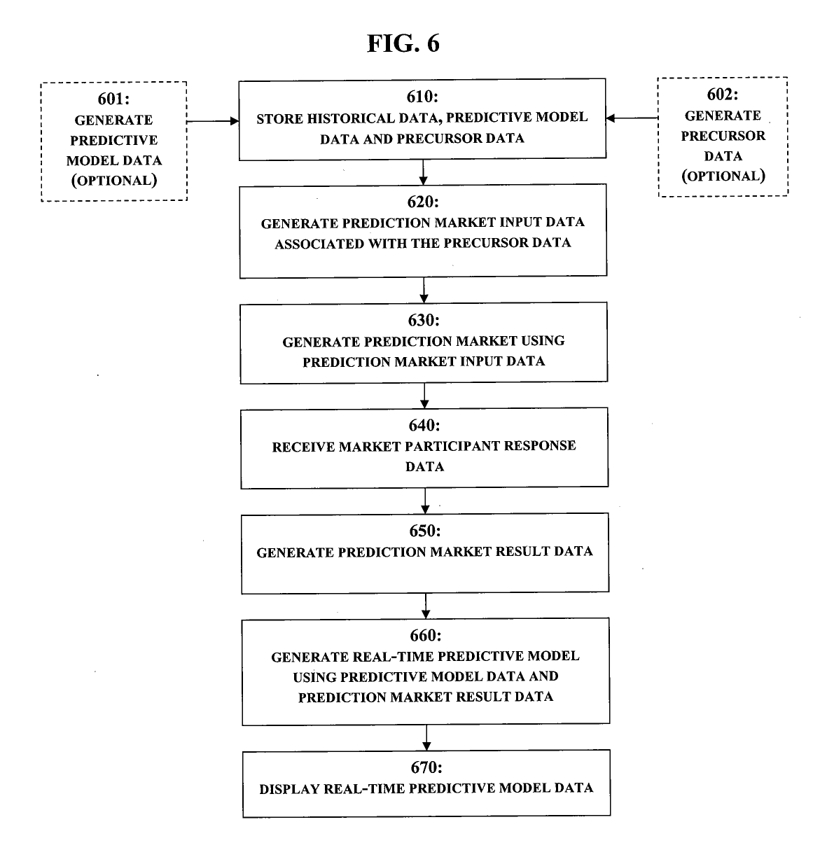

With reference to FIG. 6, a computer-implemented method 600 for generating real-time predictive model data, for example, for predicting future healthcare costs or health-related behavior associated with a population of interest, in accordance with the present invention includes:
(610) storing historical healthcare data associated with members of a population of interest, predictive model data for the population of interest, and precursor data based upon the predictive model data in at least one electronic database;
using at least one computer processor to:
(620) generate prediction market input data associated with the precursor data;
(630) generate a prediction market based upon the prediction market input data;
(640) receive market participant response data;
(650) generate prediction market result data based upon the market participant response data; and
(660) generate real-time predictive model data using the stored predictive model data and the prediction market result data; and
(670) displaying the real-time predictive model data on an electronic display.

Additionally, the method 600 may optionally include use of at least one computer processor to (601) generate the predictive model data using the stored historical healthcare data and/or (602) generate the precursor data based upon the predictive model data. The real-time predictive model data optionally may be used to update the stored predictive model data. Additionally, the historical healthcare data associated with members of a population of interest may be updated upon receipt of new actuarial data concerning the population of interest, such that the updated historical healthcare data is used to update the stored predictive model data. Also, later-received actuarial data concerning the population of interest may be used to assess the accuracy of the prediction market result data.

Embodiments of the invention can be embodied in a computer program product. It will be understood that a computer program product including features of the present invention may be created in a computer usable medium (such as a CD-ROM or other medium) having computer readable code embodied therein. The computer usable medium preferably contains a number of computer readable program code devices configured to cause a computer to affect the various functions required to carry out the invention, as herein described.

It is understood that the display screens shown and described herein are provided as examples only, and that a system embodying various aspects of the invention may be formed with or without use of these example display screens, depending upon the particular implementation.

While the methods disclosed herein have been described and shown with reference to particular operations performed in a particular order, it will be understood that these operations may be combined, sub-divided, or re-ordered to form equivalent methods without departing from the teachings of the present invention. Accordingly, unless specifically indicated herein, the order and grouping of the operations is not a limitation of the present invention.

It should be appreciated that reference throughout this specification to “one embodiment” or “an embodiment” or “one example” or “an example” or “one implementation” means that a particular feature, structure or characteristic described in connection with the embodiment may be included, if desired, in at least one embodiment of the present invention. Therefore, it should be appreciated that two or more references to “an embodiment” or “one embodiment” or “an alternative embodiment” or “one example” or “an example” or “one implementation” in various portions of this specification are not necessarily all referring to the same embodiment. Furthermore, the particular features, structures or characteristics may be combined as desired in one or more embodiments of the invention.

It should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed inventions require more features than are expressly recited in each claim. Rather, as the following claims reflect, inventive aspects lie in less than all features of a single foregoing disclosed embodiment, and each embodiment described herein may contain more than one inventive feature.

While the invention has been particularly shown and described with reference to embodiments thereof, it will be understood by those skilled in the art that various other changes in the form and details may be made without departing from the spirit and scope of the invention.

What is claimed:

1. A computer-implemented system for generating a real-time predictive healthcare model, comprising:
at least one database for storing historical healthcare data associated with members of a population of interest, predictive model data for the population of interest, and precursor data based upon the predictive model data;
a consulting terminal communicatively coupled to the at least one database, the consulting terminal comprising a computer processor programmed to generate prediction market input data based upon the precursor data;
a prediction market module communicatively coupled to the consulting terminal, the prediction market module comprising a computer processor programmed to generate a prediction market using the prediction market input data, receive market participant response data and generate prediction market result data based upon the market participant response data;
a reporting engine communicatively coupled to the prediction market module, the reporting engine comprising a computer processor programmed to receive the stored predictive model data and the prediction market result data from the prediction market module and generate real-time predictive model data; and
an electronic display for displaying the real-time predictive model data.

2. The system according to claim 1, further comprising a predictive model generator communicatively coupled to the database, the predictive model generator comprising a computer processor programmed to generate the predictive model data using the stored historical healthcare data.

3. The system according to claim 1, further comprising a precursor processor communicatively coupled to the predictive model generator, the precursor processor comprising a computer processor programmed to generate the precursor data based upon the predictive model data.

4. The system according to claim 2, wherein the real-time predictive model data is provided to the predictive model generator to update the stored predictive model data.

5. The system according to claim 1, wherein the reporting engine further includes an input component to enable a user to access the real-time predictive model data to analyze future health-related costs or behaviors for the population of interest.

6. The system according to claim 1, wherein the precursor data includes data representing at least one potential action that a member of the population of interest can take to improve the member's future health or reduce the member's future healthcare costs.

7. The system according to claim 1, wherein the historical healthcare data associated with members of a population of interest is updated upon receipt of new actuarial data concerning the population of interest, and the updated historical healthcare data is used to update the stored predictive model data.

8. The system according to claim 1, wherein later-received actuarial data concerning the population of interest is used to assess the accuracy of the prediction market result data.

9. The system according to claim 1, wherein the predictive model data and real-time predictive model data enable prediction of future healthcare costs associated with the population of interest.

10. The system according to claim 1, wherein the predictive model data and real-time predictive model data enable prediction of future healthcare behavior associated with the population of interest.

11. A computer-implemented method for generating a real-time predictive healthcare model, comprising:
storing historical healthcare data associated with members of a population of interest, predictive model data for the population of interest, and precursor data based upon the predictive model data in at least one electronic database;
using at least one computer processor to:
generate prediction market input data associated with the precursor data;
generate a prediction market based upon the prediction market input data;
receive market participant response data;
generate prediction market result data based upon the market participant response data; and
generate real-time predictive model data using the stored predictive model data and the prediction market result data; and
displaying the real-time predictive model data on an electronic display.

12. The method according to claim 11, wherein the at least one computer processor generates the predictive model data using the stored historical healthcare data.

13. The method according to claim 11, wherein the at least one computer processor generates the precursor data based upon the predictive model data.

14. The method according to claim 12, wherein the real-time predictive model data is used to update the stored predictive model data.

15. The method according to claim 11, wherein the real-time predictive model data is used to analyze future health-related costs or behaviors for the population of interest.

16. The method according to claim 11, wherein the precursor data includes data representing at least one potential action that a member of the population of interest can take to improve the member's future health or reduce the member's future healthcare costs.

17. The method according to claim 11, wherein the historical healthcare data associated with members of a population of interest is updated upon receipt of new actuarial data concerning the population of interest, and the updated historical healthcare data is used to update the stored predictive model data.

18. The method according to claim 11, wherein later-received actuarial data concerning the population of interest is used to assess the accuracy of the prediction market result data.

19. The method according to claim 11, wherein the predictive model data and real-time predictive model data enable prediction of future healthcare costs associated with the population of interest.

20. The method according to claim 11, wherein the predictive model data and real-time predictive model data enable prediction of future healthcare behavior associated with the population of interest.
